(19) United States
(12) Patent Application Publication
(10) Pub. No.: US 2010/0086728 A1
(43) Pub. Date: Apr. 8, 2010

(54) Fiber Composite Material and Sliding Board Core Made of a Fiber Composite Material Based on Wood Fiber Mats, Particularly for Skis or Snowboards

(75) Inventors: Michael Theurl, Lienz (AT); Michael Oberlojer, Amlach (AT); Rudolf Müller, Leisach (AT)

Correspondence Address: SMITH FROHWEIN TEMPEL GREENLEE BLAHA, LLC, Two Ravinia Drive, Suite 700, ATLANTA, GA, 30346, US

(73) Assignee: THEURL LEIMHOLZBAU GMBH, Assling (AT)

(21) Appl. No.: 12/525,645

(22) PCT Filed: Feb. 8, 2008
(86) PCT No.: PCT/EP08/00982

§ 371 Date: Aug. 3, 2009

(30) Foreign Application Priority Data
Feb. 9, 2007 (AT) A 214/2007

(51) Int. Cl. B32B 21/04; B32B 5/12; B32B 37/00

(52) U.S. Cl. 428/113; 428/537.1; 156/62.2

(57) ABSTRACT

The invention relates to a fiber composite material, particularly for installation in skis or snowboards. Said fiber composite material is made of a maximum possible percentage of wood fibers, which are present cross-linked among each other in the form of mats with or without preferred orientation of the fibers, and in which the thermosetting or elastomer plastics are introduced. Due a definably high and particularly uniform wood fiber density of the mats, a homogeneous material having uniform mechanical properties is achieved, which however can also be modified in a targeted manner in various locations in the core.

This patent application claims the priority of the Austrian Patent Application A 214/2007, filed on 9 Feb. 2007.

The invention relates to a fiber composite material.

The invention further relates to a sliding board core made of a fiber composite material, which is suitable in particular for incorporation in skis or snowboards.

The invention further relates to a sliding board.

Furthermore, the invention relates to a method for the production of a fiber composite material, in particular of a sliding board core.

Although several developments are already concerned with alternative materials for sliding board cores, until now wood is an almost predestined material for the manufacture of the whole cores or parts thereof, because it has some excellent mechanical properties in relation to its comparatively low gross density, which are typically due to the microscopic structure, optimized by nature, of predominantly elongated fiber cells with pore-shaped cell cavities. Specialists always stress the advantages of skis and snowboards with wood cores and always rank this product in the high price segment of the market.

With a comparatively low mass, wood has high tensile and bending strengths, a good vibration damping and high fracture toughness and displays excellent fatigue strengths, both in the case of static creep strength and also with a very high number of alternating load deformations.

As a natural raw material, certainly also within the same type of wood, it displays a typically broad distribution of its properties because of differing growth due to chronologically and spatially changeable environmental and positional conditions (variability of the wood properties). This leads to greatly dispersive technical values. Thus, for example, the gross density, which constitutes an essential factor of influence on all strength- and elasticity values, shows great differences even within the same wood board and between different production batches. In addition, wood has different properties depending on the effect transversely or longitudinally to the fiber direction or radially or tangentially to the growth rings (anisotropy of the wood properties). In addition to this is a marked hydrophilic behavior of the wood polymers, whereby even with a careful drying and storage of the dried wood under constant climatic conditions, humidity fluctuations occur.

In order to utilize the great advantages of the fiber composite material wood, which is optimized by nature, but to counterbalance its dispersive properties, wood was and is split into strips or plies, which are arranged staggered with respect to each other spatially and are then combined together again in a board form as so-called strip or ply wood. Only thereby more uniform technical values can be achieved over large industrial quantities. In a further development of this principle, for example with patent DE 3 406 056 (Franz Hess & Co, 1985) a structure made of wood sheets and hard foam became known. Further developments concerned weight reduction by the milling of grooves and slits into the core. Finally, patent EP 1 493 468 (Schwabe & Baer; 2005) with a ply wood structure made of bamboo stresses the good reception of tensile, bending and torsional stresses with a low weight.

All these products, however, are produced with great expenditure with regard to manufacture with a plurality of working steps, in which finally always a three-dimensional machining must also follow for the creation of the typical tapering contours of the cores towards their ends. Furthermore, it must be mentioned that despite the efforts shown above for more homogeneous properties of the produced wood materials, a higher variance than with plastics can not be avoided.

Other developments relate to a synthetic fiber composite material based on inorganic fibers and plastics which already in production is given the form of the sliding board core and shows an absolutely uniform structure over the large quantities of an industrial mass production. Thus, through the patent GB 804 861 (Richard Joseph Thornton, 1958) the production of a ski core made of polyester- or epoxy resins, reinforced with inorganic fibers, became known and here in particular the necessity of a good quotient of mass to strength was emphasized.

Precisely this typical wood fiber property can not be achieved conventionally with high-density inorganic fibers, for which reason cavities with costly production methods were already necessary at that time. The basis of these fibers was in fact the high values of their initial substances with respect to mass. Thus, carbon fibers have a density of approximately 1.8 g/cm³, E-glass as starting product of glass fibers has even 2.6 g/cm³. Compared with this, wood in fact also has a so-called pure density (i.e. the density determined without the characteristic fiber cell cavities, that is the pores) of on average 1.5 g/cm³, but through the cell anatomy of cell walls around a hollow interior the density by volume of the fiber composite material is substantially reduced, in spruce for example to 0.47 g/cm³.

As low a weight as possible with balanced elastic properties of the sliding board core determines the travel properties of the sliding board and remains up to the present day the essential aim of the developments in this field.

Thus, as a further type of weight reduction, a method became known with patent DE 1 809 011 (Völkl Franz OHG, 1970) which describes the core production by the filling of hollow molds with foaming thermosetting materials. Therein, however, it is also clearly stressed that the unsatisfactory bending- and torsion strengths of such foam structures must be solved by casing with inorganic fiber elements such as glass fibers or metal wires.

The technical values of foams made of thermosetting plastics, in particular those made of polyurethane, clarify this problem. High-strength RIM (“Reactive Injection Molding”) foams in fact display bending strengths of approximately 80 MPa, but have a density of 1.1 g/cm³, whereas hard integral foams with gross densities of between 0.4-0.6 g/cm³ only reach bending strengths of 20-35 MPa and bending E-moduli of between 700-1,100 MPA. Compared with this, spruce wood with established reference humidity of 12% displays a density of approximately 0.47 g/cm³ and with stress distributions parallel to the fiber on average bending strengths of 70 MPa, bending E-moduli of 10,000 MPa. A further known disadvantage of the plastics is their rapid material fatigue compared with wood and insufficient vibration damping.

Other superstructures centered on a laminated structure of the foam cores with fiber-reinforced upper and lower chords or cores with honeycomb structures, which remained hollow or were filled. This line of development continues up to the embedding of strand-shaped fiber strands oriented in the longitudinal direction of the core into thermosetting plastics, as became known from the patent FR 2 881 962 (Skis Rossignol SA, 2006). These fiber strands must, as mentioned in the patent, be produced synthetically from inorganic substances, because wood fibers can not be spun into strands or rovings.

A further disadvantage of the inorganic fibers—in connection with sliding board cores—must be described here. Glass, carbon or aramid fibers in fact have, for example, very high tensile strengths, but also likewise have very high associated elasticity moduli. Thus, glass fibers have tension E-moduli of at least 70,000 MPa, carbon fibers have such moduli of between 250,000-380,000 MPa-values which, for example, are 7 to 30 times above those of the fiber cells of spruce, for which a tension E-modulus of approximately 11,000 MPa is determined. Now, the higher an E-modulus, the more rigid the material. These inorganic fibers are therefore so rigid that with a higher fiber percentage in the plastic, the entire composite has too little bending flexibility. Here the advantage of the wood fibers becomes clearly evident, because these further contribute to the weight reduction even in the case of a high dosing in the composite material, and introduce the positive bending elastic properties of wood described above. Since in addition wood fibers are substantially more favorable with respect to mass than inorganic fibers and plastics, a cost advantage is also achieved.

The thermoplastic plastics used in addition to the thermosetting materials mentioned hitherto display a range of sufficiently known disadvantages for sliding board cores with regard to creep behavior, plastic deformability, temperature-dependent variability and high density. These also remain in the composite with fibers and can not be prevented through the fiber components.

DE 744347 discloses a ski, in particular made of plastics, wherein the insert or inserts between the outsole and the upper side of the ski consist of light structural plates. In the place of the ski grip, such a ski can have a further insert made of wood, which makes a screwing on of the binding parts possible.

GB 833721 discloses improvements in and for a ski, which is formed in a laminar type of construction with an elongated core, and has a plurality of bonded laminate layers.

EP 1,319,503 discloses a composite part of a core layer, fiber layers impregnated with polyurethane resin arranged on both sides of the core layer, a cover layer with Class A surface quality on the one fiber layer and if applicable a decorative layer on the second fiber layer.

In the publication “BAYPREG FPUR PLUS Natur inn Automobil, Verbundwerkstoffe aus Polyurethan”, Order No.: PU: 52250, Issue 3.00 of the company Bayer, composite materials for automobile construction are disclosed.

It is an object of the invention to provide a fiber composite material having favorable material properties, able to be produced with reasonable effort.

This object is solved with a fiber composite material, a sliding board core, a sliding board and a method for the production of a fiber composite material with the features according to the independent claims.

According to an example embodiment of the invention, a fiber composite material is created which is produced on the basis of wood fiber mats made of wood fibers which are felted with each other, into which thermo-setting and/or elastomer plastics are introduced.

According to another example embodiment of the invention, a sliding board core is created, which has a fiber composite material with the features described above.

According to another further example embodiment of the invention, a sliding board is provided, in particular a ski or a snowboard, which contains a sliding board core with the features described above.

According to another further example embodiment of the invention, a method is provided for the production of a fiber composite material, wherein in the method the fiber composite material is formed on the basis of wood fiber mats made of wood fibers which are felted with each other, into which thermo-setting plastics and/or elastomer plastics are introduced.

In particular, plastics which can no longer be deformed after their hardening, can be regarded as thermo-setting materials, also designated as duroplasts.

In particular, plastics which are stable in shape but are elastically deformable can be regarded as elastomers. The plastics can deform in the case of tensile- and compressive stress, but thereafter return into their original, undeformed form again.

In particular the solid or hard tissue of the shoots (stem, branches, twigs) of trees can be regarded as wood. Wood can be regarded in particular as material which stores lignin into the cell wall. Therefore, in particular a lignified (ligneous) plant tissue can be designated as wood.

In particular, physical structures which can be used for sliding on a solid or liquid base or for sliding through a fluid (for example gas, liquid) can be regarded as a sliding board.

According to the invention, the excellent properties of the fiber composite material wood, optimized by nature, can be combined with the advantages of plastics which can be produced in desired forms in one working step, and the disadvantages mentioned above with regard to the non-homogeneities in the wood and the low mechanical properties of the plastics can be excluded, wherein the mechanical properties of the fiber composite material are approximated as far as possible to those of wood, but can also be modified in a targeted manner and nevertheless as low a weight as possible is achieved.

According to an exemplary embodiment of the invention, a sliding board core made of a fiber composite material is provided, which is suitable in particular for installation in skis or snowboards. This fiber composite material contains a sufficiently high percentage of wood fibers which are present cross-linked among each other in the form of mats with or without preferred orientation of the fibers, and into which thermo-setting or elastomer plastics are introduced. Through the definably high and particularly uniform wood fiber density of the mats, a homogeneous material having uniform mechanical properties is achieved which, however, can also be modified in a targeted manner in various locations in the core.

According to the invention, the sliding board core has a fiber composite material or consists thereof, which is produced on the basis of wood fiber mats of wood fibers, felted with each other, with or without preferred orientation, into which thermo-setting or elastomer plastics are introduced. The plastic polymer undertakes here the function of the shaping binding agent.

According to the invention, above-mentioned mats offer the advantage of a wood fiber density which is definable in a targeted manner and is, above all, uniform, whereby over desired zone sections of the core also as high a percentage of wood fibers as possible can be introduced. Thereby, the mechanical properties of the core with regard to bending elasticity, vibration damping and durability are approximated as far as possible to those of wood, and in particular the dosing problems of the injection methods at the sites which are becoming thinner towards the longitudinal ends are avoided.

According to the invention, the mechanical properties can be modified in a targeted manner according to requirements at different sites in the core, as is necessary for example in the middle of the core and at the ends of the core. This is achieved by sites of higher or lower density and rigidity being created through local stacking of the mats and compacting or loosening of the mat structure, or by the mats having a preferred fiber orientation, wherein also several such mats can also be inserted crosswise one over another.

In this connection, the previously mentioned anatomical structure of the wood fibers of cell walls and cell cavities proves to be particularly advantageous, because thereby the aim of weight reduction can be kept compared with heavy inorganic synthetic fibers even in the case of high fiber percentages.

As plastic components, any thermo-setting or elastomer plastic comes into consideration, wherein it proves to be particularly advantageous if such polymers are introduced into the wood fiber mats which foam up in the course of hardening and therefore transfer the pore structure of the wood fibers into the plastic matrix. Here, the mat with the defined homogeneous fiber structure predetermines the intermediate spaces which are able to foam up, and thus guarantees a foaming with uniformly distributed pores of homogeneous size in the plastic.

In addition, it is likewise guaranteed within the framework of this invention that—as in the pure injection methods—the placing of inserts to receive binding screws or an adhesive fixed connection with laminates previously inserted into the hollow mold for upper and lower chords or similar is possible in one operating step with the insertion of the wood fiber mats.

The said wood fibers are obtained for example in thermo-mechanical decomposition methods, as have been proven for decades in the fiberboard industry. They are favorably priced and easily available with security of supply. The wood fiber mats can be produced therefrom with a density which is able to be determined in a targeted manner and with consistent felting, with or without reinforcement by plastic threads, with or without prior impregnation with synthetic resins.

The wood fiber mats are inserted, after cutting, into hollow molds which correspond to the geometry of the finished sliding board core, with the impregnation with the thermo-setting or elastomer plastic component being able to take place before insertion or also only thereafter in the mold.

The developments of the fiber composite material disclosed within the framework of this application also apply to the sliding board core, the sliding board and to the method. The developments of the sliding board core disclosed within the framework of this application also apply to the composite fiber material, the sliding board and to the method.

The position of the wood fibers in the wood fiber mat can be free of a preferred orientation, i.e. isotropic. Therefore, the wood fibers can have a statistical distribution with regard to their orientation in the fiber composite material which results in uniform mechanical properties in all directions.

Alternatively, the position of the wood fibers in the wood fiber mat can have a preferred orientation, i.e. can be anisotropic. Therefore, the wood fibers can have an ordered distribution with regard to their orientation in the fiber composite material, which results in different mechanical properties in different directions.

According to an example embodiment of the invention, a composite material on the basis of wood fiber mats and foamed (or foaming) elastomer or thermo-setting polymers and a method for the production thereof is provided. Example embodiments of the invention concern a composite material which is formed on the basis of mats, with wood fibers from the stem of lignifying plants/from thermo-mechanical decomposition methods, into which foamable (or foaming) elastomer or thermo-setting polymers are introduced, and a method for the production thereof.

According to an example embodiment of the invention, therefore a method is provided for the production of a composite material formed with wood fibers from the stem of lignifying plants/from thermo-mechanical pulping methods and foamed elastomers or thermo-setting polymers, wherein as density values those of industrially usable coniferous or leaf woods are aimed for and as high a percentage of wood fibers as possible (for example at least 30 percent by weight or at least 50 percent by weight) is to be present, which in a predeterminable uniform distribution form a connection with the foam structure of the polymer. According to the invention, a foamable elastomer or thermo-setting polymer, for example polyurethane, can be introduced into previously prepared wood fiber mats. When the percentage of wood fibers in the composite material is to be kept as high as possible, and in addition the wood fibers are to be embedded into the plastic matrix in a predeterminable uniform distribution, for the reasons previously described a suitable method can be found through the introduction of the polymer in wood fiber mats.

Without committing to a particular method for the production of such mats, it is pointed out here that in particular wood fibers from the thermo-mechanical refiner method can be used.

The stem wood can firstly be broken up and then supplied to a decomposition process, for example the thermo-mechanical refiner method. The wood fibers can be dried. As the wood fibers continuously become caught in each other and can not be dispersed loosely, these can be brought by needling into a spatially felted structure, wherein in most cases also low weight components of synthetic fibers are also introduced to reinforce the mat structure. In this form, the mats can then be handled without difficulty, cut into shape, stacked, transported and stored intermediately.

As polymer, an automatically foaming polyurethane can be used which brings with it the advantage of a long record in combination with wood. The chemical affinity to the free hydroxyl groups of the cellulose, hemicellulose and lignin molecules is, in addition, good.

Fiber mats can be provided for example with thicknesses between 2 mm and 30 mm (or higher: 50 mm or more). Thereby, for the subsequent plastic matrix, a defined space is preset, into which it can penetrate.

According to an example embodiment of the invention, a composite material of natural/wood fiber and foamed elastomer or thermo-setting polymers can be provided. Such a composite material can have at least a 40% proportion of wood fibers. A composite material can contain a combination of mats of different density/thickness. For such a composite material, automatically foaming polyurethane can be used.

A corresponding method for the production of a composite material can be developed as a continuous method. A corresponding method for the production of a composite material can alternatively be developed as a discontinuous method.

Although a range of inventions are already concerned with fiber-reinforced plastics, none of the known methods makes possible the production of a composite material on the basis of mats formed with wood fibers from the stem of lignifying plants/from thermo-mechanical decomposition methods and foamed elastomer or thermo-setting polymers, wherein as density values those of industrially usable coniferous or leaf woods are aimed for and as high a percentage as possible of wood fibers is to be present, which in a predeterminable uniform distribution form a connection with the foam structure of the polymer.

The reason for the poor suitability of the wood fibers in the existing methods for the production of fiber/polymer composites lies in their particular characteristics, which differentiates them from the other natural fibers. Firstly, these properties of the isolated wood fibers, i.e. detached from the united cell structure, are to be examined below, which are founded in the chemism of the cell wall, the anatomical structure of the united cell structure and the methods for detaching the fiber cells from this united structure, the so-called decomposition method. The industrially obtained fiber will be designated below as fiber, natural fiber, wood fiber or refiner (wood) fiber, whereas the term fiber cell refers to the anatomical individual cell in the original united cell structure.

Basically, fiber cells in all land plants form the supporting and conducting tissue, for which reason they are rather elongated and have stronger cells walls. The cell walls of the fiber cells in the stem of lignifying plants, however, differ substantially from those of the remaining fiber plants with growth times of one or a few years, in that on a molecular level between the macromolecular polysaccharides, formed as elongated strands, i.e. the cellulose and the hemicelluloses, the lignin, which is completely different therefrom and is amorphous, the “lignification or wood material”, is present in a high percentage of approximately 20 to 30 and more percent by weight and is present in such a way that it forms a matrix in which the cellulose fibrils are embedded. In the remaining natural fibers, the lignin percentage, on the other hand, varies in the single-digit percentage range, in hemp for example between approximately 2 and 5 percent by weight. Owing to the high percentage of amorphous lignin, the decomposed, i.e. isolated wood fibers are very much more brittle than those of the remaining fiber plants which are not, or are a little lignified, the cell walls of which are almost only made up of the strand-shaped cellulose structural substances.

A crucial advantage of the refiner wood fibers is, however, their consistent quality, which is due to the fact that the fiber cells in the stem wood were formed by a cambium covering, active over decades to centuries through cell division in a constantly identical form. The fiber cells of lignifying plants with secondary growth are therefore securely integrated into an extensive union of more or less identical or similar cells, wherein the elongated fiber cells of the coniferous woods are very similar and have a length of typically below 5 mm. By comparison, the quality of the fibers of the non-lignifying plants with turnover of one or a few years, is highly dependent on the growth conditions in the relevant vegetation period(s). In contrast to the fiber cell in the wood, the typical anatomical characteristic of these fiber cells is that they occur grouped to elongated fiber bundles of in part hundreds of individual cells and in addition are easily separable from the remaining, non-fibrous united cell structure. In flax, hemp, kenaf, jute and ramie for example, the fiber bundles occur in the bast, i.e. the soft part of the bark, and therefore in the border region around the shoot (“bast fibers”), whereas those of sisal are arranged embedded in the tissue of thin-walled, mostly parenchymatic cells in the leaf (“leaf fibers”).

A further essential difference between the wood fiber and the remaining natural fibers, which are all obtained from non- or slightly lignifying plants with one or a few years growth, consists, however, not only in the chemical and anatomical structure of the fiber cell itself, but significantly in the type of fiber retrieval. The fiber cell in the wood is securely integrated into an extensive association of homogeneous cells and thus builds up the stem wood with diameters and heights of known size, whereas the bast- or leaf fibers described above occur in the form of fiber bundles which are easy to isolate. Therefore, the industrial methods for decomposition and especially the fiber products are also completely different.

With the decomposition methods for fiber plants with one or a few years growth, owing to the easier detachment from the plant these long fiber bundles can be isolated almost completely in their natural length. These natural fibers are therefore, irrespective of the species, dealt with average lengths of approximately 30 cm to 60 cm and can be easily bundled into rovings, twisted into threads or ropes or additionally interwoven into fabrics or non-woven materials and, if desired, can also be cut again, i.e. divided into shorter sections.

The decomposition of stem wood, on the other hand, requires different methods. Within the framework of thermo-mechanical refiner technology, it is firstly broken down and the wood pieces are then boiled with the supply of steam and under pressure. As the pectins, the “fiber glue” which binds the individual cells to each other, are released and the amorphous lignin plasticizes, the material can be supplied to a disc refiner, a grinding tool, where the united cell structure—in contrast to the decomposition of the remaining fiber plants—is disintegrated down to the anatomical individual fiber without destroying this itself to a greater extent. In addition, however, a certain proportion of fiber bundles still remains here, which naturally have larger dimensions, even though far below those previously described. The wood fiber material which is thus obtained, also designated TMP (thermo-mechanical pulp) or refiner fibers, therefore has with regard to the lengths of its fiber components a wide range from a few 1/10 mm to over 35 mm, wherein, however, the average value is in the range somewhat below the natural length of the individual fiber, thus approximately between 2 mm and 4 mm. A normal distribution falling similarly widely applies to its diameter. The wood fibers isolated from the stem wood of trees therefore remain distinctly behind those of the fiber bundles of other natural fibers with regard to their length.

A further typical feature of these refiner fibers is that they tend to become caught in each other and felt to form wad-shaped pads. The material is therefore not in itself dispersible or pourable and can not be placed or dispersed uniformly onto a band or into a mold by simple means. The homogenous distribution of the fibers in the later plastic matrix is, however, a crucial aim, because in fact one of the advantages of the composite material indeed also lies in the avoidance of the non-homogeneous characteristics of the natural substances. Furthermore, owing to the small lengths and the brittleness of the wood fibers, a spinning into threads, ropes and suchlike and a further weaving is not possible.

A fiber composite material or a sliding board core according to an example embodiment of the invention can be provided as the basis for a ski (for example an alpine ski or a cross-country ski or a mono-ski), a snowboard, a surfboard, automobile coverings, airplane coverings, parts of furniture, panels and other covering elements for the interior and the exterior, etc. Other fields of application are possible.

For further explanation and for better understanding of the present invention, example embodiments are described in detail below with reference to the attached drawings, in which:

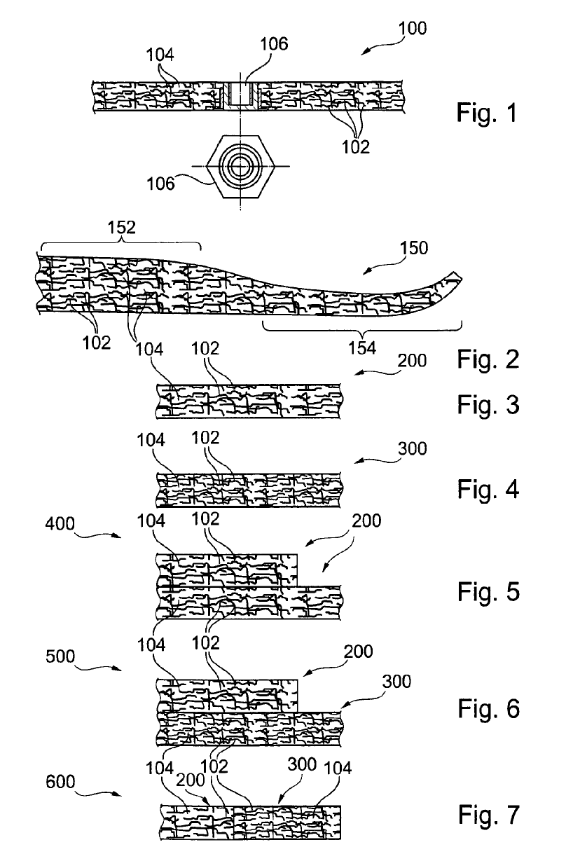

FIG. 1 shows a sliding board core with an inset insert to subsequently receive screws for a binding area of a ski according to an example embodiment of the invention.

FIG. 2 shows a sliding board core with locally compacted zones according to another example embodiment of the invention.

FIGS. 3 to 7 show various combinations of wood fiber mats of identical or different densities according to example embodiments of the invention.

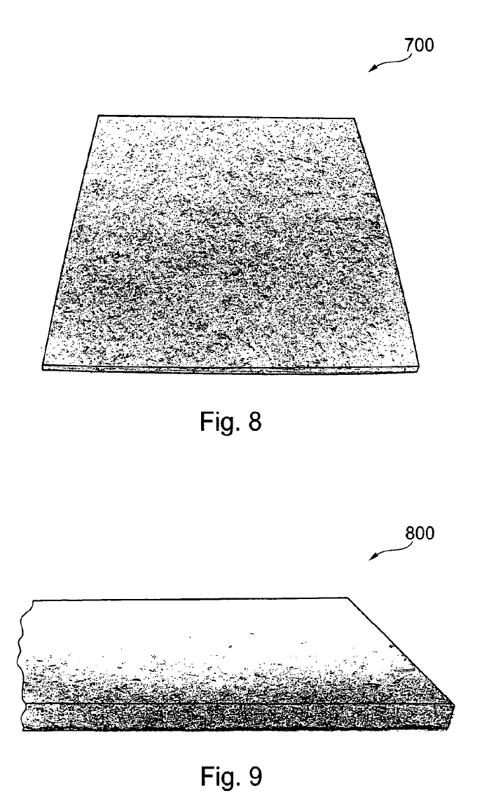

FIG. 8 and FIG. 9 show images of crude wood fiber mats for example as the basis for sliding board cores according to example embodiments of the invention.

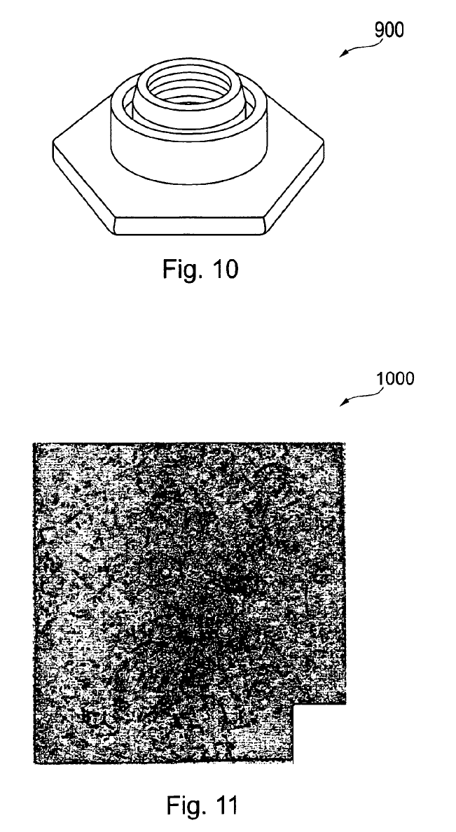

FIG. 10 shows an insert which is inserted into a fiber composite material according to an example embodiment of the invention.

FIG. 11 to FIG. 13 show a fiber composite material as is suitable in particular for sliding board cores, according to an example embodiment of the invention.

Identical or similar components in different figures are given the same reference numbers.

The illustrations of the figures are diagrammatic and not to scale.

FIG. 1 shows a cross-section of a sliding board core 100 according to an example embodiment of the invention.

The sliding board core 100 is produced from a fiber composite material which is formed on the basis of a wood fiber mat of wood fibers 102 felted with each other, into which a thermo-setting or elastomer plastic is introduced. The latter, as indicated by reference number 104, is provided into intermediate spaces between the felted wood fibers 102.

The sliding board core 100 can be provided as the basis for a ski and is distinguished in that the felted wood fibers 102 have a preferred direction, namely parallel or substantially parallel to the horizontal dimension of the sliding board core 100 according to FIG. 1.

An insert 106 is formed within the sliding board core 100 with a screw thread which can be securely connected by means of a screw or another fastening element for example to a ski binding or another element which is to be connected.

FIG. 2 shows a cross-section of a sliding board core 150 according to another example embodiment of the invention.

The sliding board core 150, as a result of corresponding processing of the wood fiber mats by means of local compacting, has different densities and wood fiber percentages in different zones of the sliding board core. More precisely, a region 152 of the sliding board core 150 is provided with a lower density than a region 154 of the sliding board core 150 with a higher density. This can be achieved for example by means of the exertion of pressure onto the region 154 of the sliding board core 150.

FIG. 2 therefore shows a sliding board core 150, in which zones 152, 154 of differing density are created by compacting the originally homogeneous and constantly dense wood fiber mat at local sites in the sliding board 150, as is necessary for example for the creation of the typical three-dimensional form together with the raised tips at the ends of the sliding board. An important point in the realization with regard to the density zones in the board is namely the fact that even with the use of an originally homogeneous wood fiber mat with originally constant density, zones 152, 154 of differing density occur, when the typical three-dimensional form of the sliding board core 150 (in the middle of the board 8 mm thick, at the ends only 3 mm) is created by pure compacting at the board ends.

FIG. 2 therefore illustrates the creation of zones 152, 154 of differing density through local compacting of the originally homogeneous wood fiber mats of constant density, for example in longitudinal direction toward the ends of the sliding board core 150. This is also due to the fact that the sliding board core 150 tapers towards the tips and thus forms a three-dimensional form. In FIG. 2 a raising of the core form at the tips of the sliding board is also shown (thicknesses compared to length illustrated exaggeratedly).

FIG. 3 to FIG. 7 show various possible combinations of wood fiber mats of differing densities with a plastic which can be used for example for a fiber composite material according to example embodiments of the invention.

FIG. 3 shows a fiber composite material 200 based on a wood fiber mat, in which wood fibers 102, felted with each other, are shown embedded into a matrix 104 of a plastic. The wood fiber mat can, for example, have a relatively low density of for example 0.05 g/cm³ to 0.15 g/cm³ (wherein here the plastic 104 is not included).

FIG. 4 shows a fiber composite material 300, based on a wood fiber mat, according to another example embodiment of the invention. Here, also, felted wood fibers 102 are provided, which are embedded into a plastic matrix 104. However, in the example embodiment of FIG. 3 the wood fiber mat is provided with a higher density than according to FIG. 2, for example approximately 0.20 g/cm².

FIG. 5 shows a fiber composite material 400 based on wood fiber mats according to another example embodiment of the invention. This is formed by, in the manner of a vertical layer model, two fiber composite material sheets 200, based on wood fiber mats of the same density, being arranged one over another and connected to each other, for example glued. On the one hand, it is possible to connect the two fiber composite material sheets 200 with each other only after the hardening of the respective plastics 104, for example to glue or screw them. On the other hand, it is possible to lay two wood fiber mats of the same density against each other and to process them jointly to a fiber composite material, by a plastic 104 being introduced into the two wood fiber mats after they have been placed against each other, and being hardened, in order to thereby form the fiber composite material sheets 200 and, at the same time, to connect them to each other.

FIG. 6 shows a fiber composite material 500 according to another example embodiment of the invention, in which a fiber composite material sheet 200 based on a wood fiber mat with a first density is connected together with another fiber composite material sheet 300 based on a wood fiber mat with a second density (which is greater than the first density). Therefore, for the example embodiment of FIG. 5 a combination of mat types of differing densities can be used for the formation of the fiber composite material 500 in the manner of a vertical layer model. Different wood fiber mat densities in different zones of the fiber composite material 500 can serve for example to fulfill different stability and/or flexibility requirements depending on location. On the one hand, it is possible to connect the two fiber composite material sheets 200, 300 with each other only after the hardening of the respective plastics 104, for example to glue or screw them. On the other hand, it is possible to lay two wood fiber mats of differing density against each other and to process them jointly to form a fiber composite material, by firstly, after placing together, a plastic 104 being introduced into both wood fiber mats and being hardened, in order to thereby form the fiber composite material sheets 200, 300 and at the same time to connect them with each other.

FIG. 7 shows a fiber composite material 600 according to an example embodiment of the invention. In this, a fiber composite material sheet 200 on the basis of a wood fiber mat with a first density and another fiber composite material sheet 300 on the basis of a wood fiber mat with a second density (which is greater than the first density) are connected with each other laterally. In other words, a fiber composite material sheet 200 and a fiber composite material sheet 300 are arranged laterally to each other or adjacent to each other and are glued to each other on a narrow side/side surface, so that the broad sides/main surfaces of the fiber composite material sheets 200, 300 do not touch each other. Different wood fiber mat densities in different zones of the fiber composite material 600 can serve for example to fulfill different stability and/or flexibility requirements depending on location. On the one hand, it is possible to connect the two fiber composite material sheets 200, 300 with each other only after the hardening of the respective plastics 104, for example to glue or screw them. On the other hand, it is possible to lay two wood fiber mats of differing density against each other and to process them jointly to a fiber composite material, by a plastic 104 being introduced, only after the placing against each other, into both wood fiber mats and being hardened, in order to thereby form the fiber composite material sheets 200, 300 and at the same time to connect them with each other.

In the example embodiment according to FIG. 7, mat types of differing density can be combined in the longitudinal direction of the fiber composite material 600, for example in order to produce a higher density and rigidity at pointed zones.

FIG. 8 shows an image 700 of a wood fiber mat in top view as the basis for a sliding board core according to an example embodiment of the invention.

FIG. 9 shows another image 800 of the wood fiber mat of FIG. 8.

FIG. 10 shows with an image 900 how an insert element (for example a connection arrangement for connecting a fiber composite material sheet with an element which is to be connected) is included into a wood fiber mat. The insert element can either be cast into the wood fiber mat, by the wood fiber mat, after the addition of the insert element, being cast with the integrated insert element by means of a plastic. Alternatively, the insert element can be formed after the introduction and hardening of plastic into the wood fiber mat in the resulting fiber composite material sheet, by for example the insert element being inserted into a bore of the fiber composite material sheet and connected therewith (glued, for example).

FIG. 11 shows a fiber composite material 1000 according to an example embodiment of the invention, in which inserts are formed which are previously pressed into the mat and are thereafter foamed in.

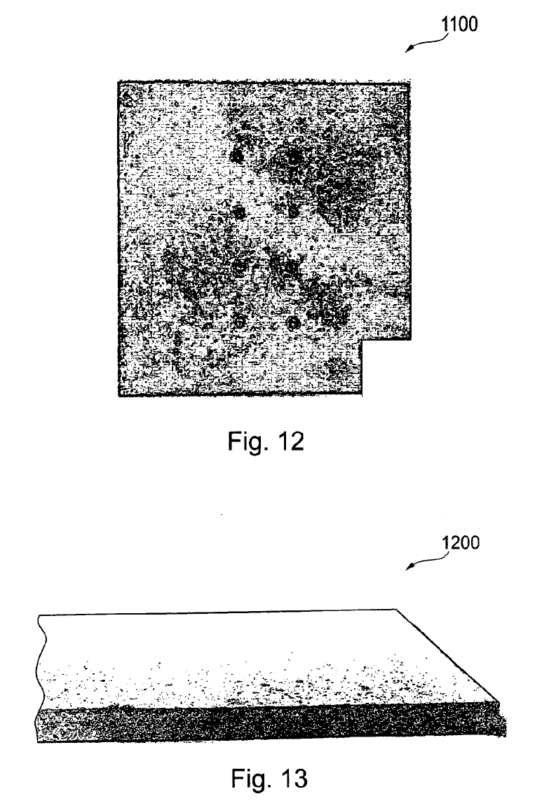

FIG. 12 shows another fiber composite material 1100 according to an example embodiment of the invention.

FIG. 13 shows a cross-section of a fiber composite material sheet 1200 according to an example embodiment of the invention.

Methods are described below for the fiber mat foaming according to example embodiments of the invention.

For the formation of fiber composite materials for example for sliding board cores for example fiber mats of the manufacturer Faurecia (mats of coniferous wood refiner fibers, weight per unit area 1,200 g/m² to 1,800 g/m²; density with thickness 8 mm: 0.15 g/cm³ or 0.22 g/cm³) and of the manufacturer BO-System (mats of coniferous wood refiner fibers with weight per unit area 1,800 g/m²) can be used.

A metal sleeve with internal thread can be used as the insert for example, wherein on the base this can be provided extending in round or hexagonal form and can have a plastic jacket.

Thereby, a composite with an overall density in the range of light leaf or coniferous woods can be produced (for example between 0.40 g/cm³ and 0.45 g/cm³). However, it is also possible to produce lighter composite materials, for example with a density of 0.35 g/cm³. The composite is technologically in competition to solid wood cores, which for example can be produced laminated from poplar, paulownia (foxglove tree from East Asia, a very light wood) and can have a density over the entire laminated cross-section of for example approximately 0.43 g/cm³. Pure PUR cores (polyurethane) with a density of approximately 0.64 g/cm³ are another comparison standard.

The core has an influence on the board properties of a sliding board core produced therefrom. The requirements are therefore to be undertaken with regard to the material characteristics so that in particular a desired bending resistance and a desired bending elasticity are able to be achieved. It is also possible to adapt the pull-out strength of the inserted insert, which can receive the subsequent binding screws, to particular requirements for sliding boards. For example, a standard requirement for such sliding boards can be 4,500 Newton. It is also possible to examine snowboards, which are produced accordingly, with fatigue, slap, fracture or respectively edge pull-out tests.

Wood fiber mats offer the advantage that the inserts can be pressed into the mat before foaming and thus are fixedly foamed in with the action of the PUR (polyurethane foam). Thereby, a good insert pull-out strength is able to be achieved, and the standard default value of 4,500 Newton can be readily achieved and even exceeded.

A production method is described in detail below.

In a first step, for example Modipur 541 can be used.

For this, for example Modipur US 541/22 of Hexcel Composites can be used as a CFC-free polyurethane system (4,4′-diphenylmethane diisocyanate+polyol+small percentage of amines as activator). The viscosity of the mixed system can be kept below 2,000 mPa·s. As a field of application, the ski industry is to be mentioned, especially for PUR cores produced by injection method. Up to the start of the foaming, the open time can be approximately 30 seconds, with the setting time being able to be approximately 1 minute.

In a second step, a fiber mat foaming can be carried out without a mold. The fiber mat can be acted upon on both sides with a particular quantity of PUR, and the emerging or foamed-out PUR on the mat surface can be removed again.

In a third step, the fiber mat foaming can be carried out in a mold.

A particular mold can be produced. With a parameter of the overall density of approximately 0.40 g/cm³ and a density proportion of the mat of approximately 0.20 g/cm³, the remaining quantity of PUR can be mixed. A portion (for example half) thereof can be firstly filled into a mold. Then a mat can be inserted. Another portion (for example the other half) can be coated onto the mat. The mold can be closed for example mechanically, hydraulically or pneumatically.

The said mold can also serve in an industrial production process to receive the upper and lower chords (for example of glass fiber-reinforced non-woven material) lying on the upper side and lower side of the sliding board core, which at the same time can be glued in such a way securely with the sliding board core in the course of the introduction of the PUR, and can provide the typical three-dimensional form of the sliding board core.

It should be ensured that the applied quantity of PUR is sufficient for a complete penetration of the wood fiber mat. The overall density of a corresponding device is to be approximately 0.40 to 0.45 g/cm³.

The foaming takes place relatively quickly. Therefore, the time for precise coating of the PUR is short, so that this process step is to be carried out sufficiently quickly.

In a fourth process step, an optimization can be carried out via a PUR system.

Here, the requirements for low viscosity for better impregnation and a sufficiently long open time and a sufficiently good handling are to be respected.

Modipur US 23 of Hexcel Composites can be used as the system. This is a pure isocyanate prepolymer (main component 4,4′-diphenylmethane diisocyanate with a predefined quantity of higher functional isocyanates). The viscosity can be approximately 200 mPa·s. A hardening can be carried out for example with air- or wood humidity. Accordingly, without acceleration of the hardening process, a relatively long open time is provided, for example more than 12 hours. A substantial acceleration of the hardening can be achieved by action with heat.

With the use of a Modipur US 23 (isocyanate) plus Modipur US 566 mod.5 (polyol), a mixture of 100 parts by weight US 566 to 135 parts by weight US 23 can take place. The PUR system can be used with a longer open time.

By carrying out this method, the handling can be greatly improved in the impregnation.

To reduce the viscosity, the component “polyol Modipur US 541 or Modipur US 566 mod.5” can be heated to approximately 30° C. to 35° C. The viscosity of the mixed system can become correspondingly less (thinner), whereas the start time, the window of time of mixing the components up to the start of the foaming, does not reduce so far such that a good handling can not nevertheless be guaranteed. The impregnation of the wood fiber mat with a fixed ratio of for example 1 part by weight wood fiber mat (with approximately 8 mm thickness and approximately 0.20 g/cm³) to 1 part by weight mixed PUR can thus be further improved. This has proved to be more advantageous than a heating of both components (isocyanate and polyol). In fact, in the latter case the viscosity is further reduced, however the start time tends towards a value which is not preferred.

According to an example embodiment, an application of pressure can be provided, which makes possible a better delivery of the PUR into the middle of the mat through higher pressures. Also, non-compacted wood fiber mats can be used, which with the same weight per unit area of 1,800 g/m² have a thickness of for example 35 mm and therefore a density of only approximately 0.05 g/cm³. In both cases it is possible, after the application of the PUR, to place the mat under applied pressure to such an extent that it is compressed under the desired final thickness and the PUR is thus delivered uniformly down to the middle of the mat. Following on from this, and still before the start of the foaming, the pressure is removed again and the mold is taken back to the final thickness which is to be achieved, whereby the mat relaxes again and in addition in the course of foaming is returned by the foam pressure from the interior back to the final thickness.

An example for the dimensioning of a sliding board is a thickness of approximately 8 mm to approximately 3 mm, decreasing in longitudinal direction from the middle of the sliding board towards the tips, a width of approximately 24 cm to approximately 29 cm and a length of approximately 155 cm.

The wood fiber percentage in the overall mass of the composite can be for example greater than 50%, or else 30% or more. A suitable range for the mass percentage of the wood fibers lies between 20% and 70%, in particular between 40% and 60%.

Suitable density zones lie in a sliding board core at approximately 0.35 g/cm³ to 0.45 g/cm³. In more highly compacted regions, however, densities of approximately 0.65 g/cm³ and more are also possible. In addition to a high stability, however, also a light weight is desirable, so that a preferred range of values lies between 0.30 g/cm³ and 0.65 g/cm³, in particular between 0.35 g/cm³ and 0.45 g/cm³.

Wood fiber mats, compared with other natural fiber mats, have significant advantages for the invention. These include the consistent quality of the wood fibers owing to the previously described biological connections with respect to the qualities of natural fibers of 1 year or few years' growth, fluctuating from crop year to crop year. The substantially higher reliability of supply of the wood fibers is a further important advantage, because already the sustainably managed stock of wood in the world alone is substantially greater than that of other economically utilized natural fiber plants. A crucial advantage of the wood fibers is therefore their worldwide reliability of supply, which in addition are available without the typical fluctuations in the success of harvesting which are typical of seasonally cultivated fiber plants. In addition, waste products of the timber and forestry industry are available for defibration, which can be utilized in accordance with the invention. Additionally, several natural fibers different from wood have the disadvantage of marked odors, compared with wood. According to the invention, a new wood material is clearly provided.

This invention is not restricted in its execution to the preferred embodiments illustrated in the figures. Rather, a plurality of variants are conceivable, making use of the represented solution and the principle according to the invention also in the case of embodiments of a fundamentally different nature.

In addition, it is pointed out that “having” does not rule out any other elements or steps and “a” or “one” does not rule out a plurality. It is further pointed out that features or steps which have been described with reference to one of the above example embodiments can also be used in combination with other features or steps of other example embodiments described above. Reference numbers in the claims are not to be regarded as restrictions.

1. A fiber composite material, which is produced on the basis of wood fiber mats of wood fibers which are felted with each other, into which thermo-setting plastics and/or elastomer plastics are introduced.

2. A sliding board core which has a fiber composite material according to claim 1.

3. The sliding board core according to claim 2, which consists of the fiber composite material.

4. The sliding board core according to claim 2, wherein the position of the wood fibers in the wood fiber mat has a preferred direction, in particular parallel to a longer dimension of the core.

5. The sliding board core according to claim 2, wherein the position of the wood fibers in the wood fiber mat is free of a preferred direction.

6. The sliding board core according to claim 2, wherein two or more wood fiber mats with a preferred orientation of the wood fibers are laid one over another and these have preferred orientations of the wood fibers crossed with respect to each other in different angles, in particular a right-angle of 90°.

7. The sliding board core according to claim 2, wherein a three-dimensional shaping is achieved by cutting or milling the wood fiber mats and by layering of two or more wood fiber mats in the form of a vertical layer model.

8. The sliding board core according to claim 2, wherein by using a uniform density of the wood fiber mats over their entire width and length, a uniform dosing of the wood fiber percentage is achieved in the entire sliding board core.

9. The sliding board core according to claim 8, wherein the sliding board core has differing densities and wood fiber percentages at differing sliding board core zones through the processing of the wood fiber mats, such as for example compacting or loosening.

10. The sliding board core according to claim 2, wherein the wood fiber mats are impregnated with a liquid thermo-setting or elastomer plastic, which is foamed in the course of hardening and through the defined uniform structure of the wood fiber mats lines the fiber intermediate spaces homogeneously.

11. The sliding board core according to claim 2, wherein a reduction to the mass of the composite material is achieved by the introduction of as high a wood fiber percentage as possible, in particular a wood fiber percentage of at least 40%, due to the natural cell cavities.

12. The sliding board core according to claim 2, which has a three-dimensional form which is formed by cutting or milling the wood fiber mats.

13. The sliding board core according to claim 2, which has a three-dimensional form, which is formed by layering of two or more wood fiber mats in the form of a vertical layer model.

14. The sliding board core according to claim 2, which has a three-dimensional form which is formed by cutting or milling the wood fiber mats and subsequent layering of two or more previously cut or milled wood fiber mats in the form of a vertical layer model.

15. The sliding board, in particular ski or snowboard, which contains a sliding board core corresponding to claim 2.

16. A method for producing a fiber composite material, wherein in the method the fiber composite material is produced on the basis of wood fiber mats of wood fibers which are felted with each other, into which thermo-setting plastics and/or elastomer plastics are introduced.

17. The method according to claim 16, wherein a sliding board core is produced from the fiber composite material.
